(19) United States
(12) Patent Application Publication
(10) Pub. No.: US 2012/0325565 A1
(43) Pub. Date: Dec. 27, 2012

(54) THERMALLY STABLE POLYCRYSTALLINE DIAMOND

(76) Inventor: Zhigang Z. Fang, Salt Lake City, UT (US)

(21) Appl. No.: 13/294,089

(22) Filed: Nov. 10, 2011

Related U.S. Application Data
(63) Continuation-in-part of application No. 13/167,556, filed on Jun. 23, 2011.

(51) Int. Cl. E21B 10/46; B01J 3/06; B24D 3/10

(52) U.S. Cl. 175/434; 51/309

(57) ABSTRACT

The present disclosure provides compositions and methods directed to polycrystalline diamond materials. In one embodiment, a polycrystalline diamond material can comprise sintered polycrystalline diamond and a binder alloy, where the binder alloy is a liquid at a sintering temperature of the polycrystalline diamond, forms an intermetallic compound at a low temperature below the sintering temperature, and is substantially all intermetallic phase.

### RELATED APPLICATION

This application is a continuation-in-part application of U.S. patent application Ser. No. 13/167,556 filed Jun. 23, 2011 which is incorporated herein by reference.

### FIELD OF THE INVENTION

The present invention relates generally to a polycrystalline diamond material. More particularly, the present invention relates to compositions and methods for polycrystalline diamond material having thermally stable characteristics. As such, the present invention relates to the fields of chemical engineering, chemistry, metallurgy, material science, and petroleum engineering.

### BACKGROUND OF THE INVENTION

Polycrystalline diamond compacts (PDC), also known as shear cutters, are critical cutting components on a PDC bit. Such bits can be used for petroleum drilling. FIG. 1 illustrates shear cutters used on a PDC bit as commonly used in the industry for many years. FIG. 2 illustrates how an individual cutter interacts with the rock formation during drilling. The shear cutters can be designed and fabricated with a polycrystalline diamond overlay 20 on a cemented tungsten carbide substrate 10. The cemented tungsten carbide substrates 10 provide a rigid support to the diamond layer 20. Generally, the diamond layer is in direct contact with the rock formation during drilling along its cutting surface 30 while the flank surface 40 trails behind as the cutter moves across a rock formation. The extremely high wear resistance of diamond leads to the excellent durability of the cutters, and the bit, that would not have been possible with other materials. However, continued improvement in drilling technology and ever increasing demand for higher productivity has generated a strong need for further improvement in cutter technology.

In particular, aggressive cutting can result in production of substantial amounts of heat which can detrimentally affect the diamond material. For example, small amounts of sintering aid and other metals are typically present within the polycrystalline diamond. As these metals reach sufficiently high temperatures they can begin to catalyze conversion of the diamond back into carbon. Various methods are used to minimize this effect such as leaching the metals from the polycrystalline diamond and the like. Metals can provide benefits such as increased toughness and reduction in brittleness. As such, these methods are limited in their effectiveness to achieve both more thermally stable PDC materials and commercially valuable materials having high toughness.

### SUMMARY OF THE INVENTION

Accordingly, it has been recognized that there is need for compositions and methods of producing high-quality polycrystalline diamond materials, especially for use in drilling applications, which exhibit increased thermal stability and corrosion resistance.

As such, the present disclosure provides a polycrystalline diamond material comprising sintered interconnected and inter-bonded synthetic diamond grains with a binder alloy located in pockets in between diamond grains. The binder alloy can have specific properties which allow these improvements to be achieved. In one aspect, the binder alloy can be a liquid at a sintering temperature of the polycrystalline diamond, and can form an intermetallic compound alloy at temperatures lower than the sintering temperature (including at room temperatures) in solid state. As solid phase(s) at temperatures lower than the sintering temperature, the binder alloy is also substantially all intermetallic throughout the material. As such, the binder alloy and material does not include substantial elemental metal phase region or a solid solution alloy. The intermetallic compound alloy has no or little solubility for carbon in solid state at those temperatures.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic of a typical PDC bit for petroleum drilling used by the industry. Materials of the present invention can be used in connection with such bits;

FIG. 2 is a schematic of a PDC cutting rock formation by shearing as typically occurs with prior art bits;

FIGS. 3A and 3B shows binary phase diagrams for B—C (3A) and B—Co (3B) for use in formulating suitable materials in accordance with an embodiment of the present invention;

FIGS. 4A and 4B shows binary phase diagrams for Al—Co (upper) and Al—Cr (lower) for use in formulating suitable materials in accordance with an embodiment of the present invention;

FIG. 5 shows a binary phase diagram for C—Si for use in formulating suitable materials in accordance with an embodiment of the present invention;

FIG. 6 shows a binary phase diagram for Co—Si for use in formulating suitable materials in accordance with an embodiment of the present invention; and

FIG. 7 shows a binary phase diagram for C—Co for use in formulating suitable materials in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

It is noted that, as used in this specification and the appended claims, the singular forms “a,” “an,” and “the” include plural referents unless the context clearly dictates otherwise. Thus, for example, reference to “an alloy material” includes one or more of such materials, reference to “a layer” includes reference to one or more of such structures, and reference to “a sintering step” includes reference to one or more of such steps.

In describing and claiming the present invention, the following terminology will be used in accordance with the definitions set forth below.

As used herein, “intermetallic alloy” refers to an alloy having a fixed and known formula and corresponding crystal structure. This is in contrast to an alloy which may exist as a “solid solution alloy” where one or more elements are randomly positioned between crystal lattice positions of the primary lattice components. Such solid solution alloys include elements not oriented at regular lattice positions. In many cases, chemical composition of an intermetallic alloy may vary within a rather narrow compositional range.

As used herein, “weak carbide formers” refers to elements of which its chemical affinity to carbon is weaker than that of tungsten W, Mo, Cr, Nb, Ti, Ta, V, Zr, Hf, and Fe.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, the term “substantially” refers to the complete or nearly complete extent or degree of an action, characteristic, property, state, structure, item, or result. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. In other words, a composition that is “substantially free of” an ingredient or element may still actually contain such item as long as there is no measurable effect thereof.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 10 to about 50” should be interpreted to include not only the explicitly recited values of about 10 to about 50, but also include individual values and sub-ranges within the indicated range. Thus, included in this numerical range are individual values such as 20, 30, and 40 and sub-ranges such as from 10-30, from 20-40, and from 30-50, etc. This same principle applies to ranges reciting only one numerical value. Furthermore, such an interpretation should apply regardless of the breadth of the range or the characteristics being described.

The present inventor has recognized that it would be advantageous to develop shear cutters that can be subjected to higher stress, harder rock, and more impact load conditions. As such, a typical failure mode of shear cutters is the degradation of the cutter due to graphitization of diamond in the presence of cobalt at high temperatures, and/or corrosion-oxidation of the cobalt phase which leads to microcracks. To that end, polycrystalline diamond (PCD) with conventional cobalt catalytic binder is considered thermally unstable. Thus, novel PCD materials that improve bit life and durability allowing for deeper and harder drilling are described more fully in the following detailed description. Additionally, the present disclosure provides improved thermal stability of the polycrystalline diamond compact such as a shear cutter, without compromising wear resistance, toughness, cost of manufacturing, and environmental waste.

Traditional PCD use transitional metals such as Co, Ni, and Fe, but primarily cobalt as catalytic binders. The roles of catalytic transition metal binder during sintering of synthetic diamond have been extensively studied. The role of such catalytic transition metal binders involves diamond dissolving into the metal binder at high temperatures and re-precipitates as diamond on either existing diamond particles or the bond between diamond particles. As sintering progresses, individual diamond particles grow together to form an interconnected network of polycrystalline diamond with the binder trapped within the network. The metals can act as a “binder” or filler in the inter diamond particle pore spaces. The presence of ductile metal binders is beneficial for better toughness and impact resistance of the PCD material.

Polycrystalline diamond is a class of superhard materials made by high temperature and high pressure consolidation processes (HTHP). PCD, as used in the industry, refers to the materials made of synthetic diamond grains and second phase additives or metal elements. Diamond grains are bonded amongst themselves to form a substantially continuous network of diamond material. Second phase additives and metal elements are usually cobalt metal (Co) and tungsten carbide (WC) particles. Co and WC can either be mixed with synthetic diamond powder before HTHP processing, or, Co may be obtained from WC—Co substrates on which PCD is pressed during HTHP consolidation. In the second case, Co migrates or diffuses into the compact of diamond particles as sintering progresses.

The composition of polycrystalline diamond materials usually contains 10 to 30 percent by weight metals such as cobalt. Minor additives may include WC, TiC, Nb and NbC, Ni, Fe, and so on. For any given grain size of the diamond phase, the impact resistance is proportional to the metal content (i.e. increased impact resistance with increasing metal content) while the wear resistance is proportional to the diamond content (i.e. increased wear resistance with increasing diamond content) and inversely proportional to the size of diamond grains. The properties of the PCD material can thus be tailored by varying the metal content and the grain size of diamond particles to balance wear resistance and impact resistance.

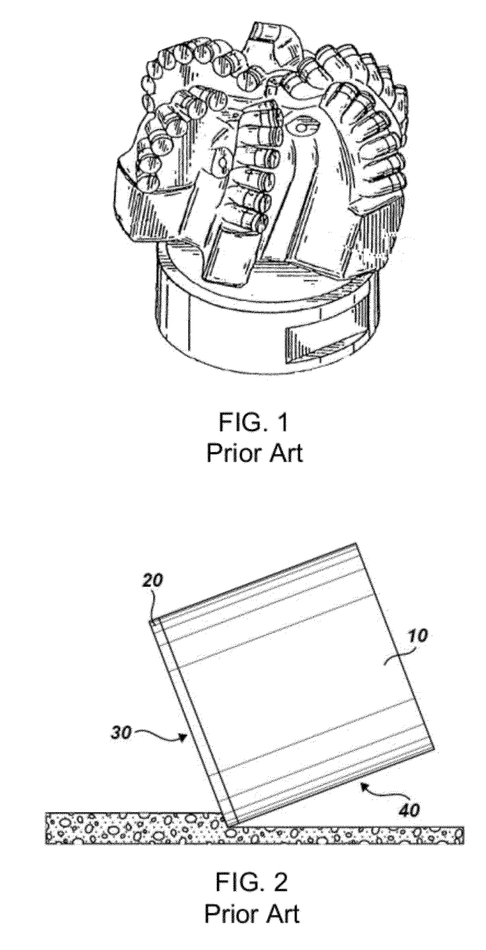

PCD has many industrial applications. Two primary applications are rock drilling and metal cutting. For example, PCD is used to make shear cutters. Shear cutters are the cutting components on a PDC bit for oil and gas explorations. FIG. 1 illustrates shear cutters used on a PDC bit where multiple shear cutters are mounted on a bit body. FIG. 2 illustrates how an individual cutter interacts with the rock formation during drilling. The shear cutters are designed and fabricated with a polycrystalline diamond overlay 20 bonded on cemented tungsten carbide substrates 10. The cemented tungsten carbide substrates 10 provide a rigid support to the diamond layer 20, which is in direct contact with the rock formation during drilling. PCD material is extremely wear resistant which leads to excellent durability of the cutters and a bit having performance that would not have been possible with other materials. However, continued improvement in drilling technology and ever increasing demand for higher productivity has pushed the limits of currently available materials. Current shear cutters are often subjected to higher stress, harder rock, and more impact load conditions. As a result, typical failure modes of shear cutters are by edge chipping and eventual catastrophic breakage.

PCD is also used for metal cutting. Usually, PCD is pressed on a WC—Co substrate. The PCD laminated blank is then cut into small pieces and brazed onto another solid body for incorporation into a tool. PCD cutting tools are used for cutting abrasive materials including metal matrix composites where the reinforcement phase, such as SiC, are very detrimental to tool life. In general, PCD tools have far longer tool life than cemented tungsten carbide tools or other ceramic cutting tools. PCD cutting tools are also used in woodworking industry. PCD tools are also used extensively in mining operations as well as construction and demolition tools. PCD is also considered as suitable candidate material for biomedical engineering applications such as artificial hips. This suitability is at least partially because PCD is biocompatible and has very substantially longer durability than similar components made of metal alloys.

The common rational for using PCD in drilling, cutting, or wear applications is based on its extremely high hardness, high wear resistance, and high thermal conductivity. On the other hand, a common failure mode for PCD during these applications is fracturing and catastrophic breakages. It is highly desired to improve the chipping and breakage resistance of PCD materials.

There are different mechanisms that are attributed to the cracking and fracturing process of PCD material. Among them, preferential corrosion of the cobalt phase, or other metal additives, is identified for many applications including rock drilling where certain formations and drilling fluid are corrosive, metal cutting and woodworking where chemical interactions with the work piece causes the loss of metals, and biomedical applications where the interaction with body fluid accelerates the degradation of the components. The consequences of preferential corrosion and loss of the cobalt phase, which to a certain extent has the role of a binder, are the weakening of the microstructure, the initiation of micro cracks and micro chipping, and the loss of diamond grains. Accumulated effects of these microstructure degradations are manifested on a macro level as either the accelerated “wear” or fracture and catastrophic breakage of the PCD material.

The preferential corrosion of cobalt is also linked to thermal degradation of components made of PCD materials. This scenario is possible because the temperatures at the cutting edges during many applications are very high (>500° C.). The preferential corrosion or degradation of cobalt can be accelerated or exacerbated under high temperature conditions. Another apparent factor is that the solubility of carbon in the cobalt phase increases with increasing temperature. If the components are exposed to high temperature for extended times in repeated cycles, the dissolution of diamond grains into the cobalt metal can become a significant factor that affects the mechanical integrity of the component. In any event, it is highly desirable to have a method that will prevent the preferential corrosion and loss of cobalt or binder phase. It is also desirable to maintain a low temperature at the surface or cutting edge where the tools engage work pieces or environments to maintain the integrity and stability of the PCD material.

As such, the present disclosure provides a polycrystalline diamond material comprising sintered interconnected and inter-bonded synthetic diamond grains with a binder alloy located in pockets in between diamond grains. The binder alloy can have specific properties which allow these improvements to be achieved. In one aspect, the binder alloy can be a liquid at a sintering temperature of the polycrystalline diamond, and can form an intermetallic compound alloy at temperatures lower than the sintering temperature (including at room temperatures) in solid state. The binder alloy is also substantially all intermetallic throughout the material at temperatures below the sintering temperature. Typical sintering temperature of PCD is between 1300 and 1600° C. As such, the binder alloy and material does not include substantial elemental metal phase region or a solid solution alloy. The intermetallic compound alloy in solid state has no or little solubility for carbon.

An additional consideration which can contribute to performance of the binder alloy is choosing an alloy which is a solid at room temperature and solubilizes carbon in the amount of 1.0 percent or less. By limiting the carbon solubility in the binder alloy, the degradation of PCD during service at relatively high temperatures can be avoided or minimized. The binder alloy can also be a liquid at sintering temperatures from about 1300° C. to about 1600° C.

The binder alloy generally can have the formula M₁ₓM_{2y}, where M₁ is a sintering catalyst, M₂ is an alloying element, and each of x and y are non-zero positive numbers corresponding to a particular atomic ratio in the respective phase of the alloy. Non-limiting examples of suitable sintering catalyst include Co, Fe and Ni. In one embodiment, M₁ is Co. In another embodiment, M₁ is Fe, or Ni, or other transition metals. As a result of the binder alloy, the polycrystalline diamond material can have a high thermal stability. Although other alloying elements can satisfy these criteria, non-limiting examples of suitable alloying elements (M₂) can include B, Al, Cr, Mn, Si, Y, W, V, Mo, Nb, Ti, Zr, Hf, Ta, Re, and combinations thereof. In one specific example, the alloying element can be B. Choice of these alloying elements also requires consideration of their proportion in the binder alloy such that elemental phase of either sintering catalyst or alloying element is avoided at low temperatures. Some trace amounts of elemental phase may be acceptable as long as it does not measurably reduce thermal stability of the material. Specific proportions which achieve these results is largely dependent on the relevant phase behavior and corresponding phase diagrams of the chosen system as illustrated with several specific systems below. Further, the binder alloy and alloying element in particular does not form carbide or is a weaker carbide former than tungsten. In some cases, the intermetallic compound alloy is a mixture of multiple phases. Typically, the intermetallic compound alloy is not a solid solution alloy.

In one embodiment, the binder alloy can be selected from the group consisting of Co—B; Co—Al; Co—Cr; Co—Mn; Co—Si; Co—Y; Co-M, where M is one of, or mixtures of, W, V, Mo, Nb, and Ti; and mixtures thereof. Specific intermetallic compounds can include, but are not limited to, Co₃B, Co₂B, CoB, Al₉Co₂, Al₁₃Co₄, Al₃Co, Al₅Co₂, AlCo, Al₇Cr, Al₁₁Cr₂, Al₄Cr, Al₉Cr₄, Al₈Cr₅, AlCr₂, SiC, Co₃Si, Co₂Si, CoSi, CoSi₂, and the like.

Carbon containing systems can also be suitable. For example, the intermetallic compound alloy can have the formula M₁ₓ-M_{2y}-C_{z}, where M₁ is a sintering catalyst and M₂ is an alloying element and z, y and z correspond to a particular atomic ratio in the respective phase of the alloy. In another embodiment, the binder alloy can be binary and becomes a ternary system during sintering having the following structure Co-M-C, where M is B, Al, Cr, Mn, Si, Fe, Ni, Ti, Ta, W, V, Mo, Nb, or Ti. In one aspect, the binder alloy can be Co—B, where the boron is present in the alloy in a concentration of at least 20% by atomic ratio (molar fraction). In some cases the boron can be present at greater than 25% by atomic ratio.

The thermally stable polycrystalline diamond material can typically be formed directly on a substrate body. Often a cemented tungsten carbide substrate composed primarily of tungsten carbide embedded in a cobalt metal matrix is used, although other materials such as, but not limited to, cermets can also be used. Such materials allow for attachment to a tool body via brazing, welding, mechanical latching, interference fit or other mechanisms. A wide variety of tools can use the thermally stable polycrystalline diamond material. In one aspect, the tool can be selected from the group consisting of shear cutter, drill bit, metal cutting tool, woodworking tool, construction tool, demolition tool, dental work tool, and biomedical tool. In one specific aspect, the tool can be a drill bit.

Further, the present disclosure provides for a method of manufacturing a thermally stable polycrystalline diamond material comprising: forming a compact of particulate diamond and binder alloy, the binder alloy including a sintering catalyst and at least one alloying element selected from the group consisting of B, Al, Cr, Mn, Si, Y, W, V, Mo, Nb, and Ti and sintering the compact under high temperature and/or high pressure. The sintering is sufficient to form the thermally stable polycrystalline diamond material. Furthermore, the alloying element is present at an amount sufficient that the binder alloy forms an intermetallic compound alloy at low temperatures (including room temperature) in solid state and is substantially all intermetallic phase subsequent to sintering. The high temperature and high pressure (HTHP) process conditions for making PCD materials herein are similar or identical to that of the industry standard for conventional PCD. The selection of diamond grain size can vary for different grades of PCD intended for different industrial applications.

The basic procedure for sintering can generally follow conventional processing, with the important distinction of the choice of starting materials. The starting materials are often particulate and powder materials, although solid plates or foils can also be used such as for the binder alloy and/or components thereof.

For example, the compact can be formed by mixing the particulate diamond with the binder alloy in the form of a particulate binder alloy. In this case particle size can affect the homogeneity of mixing and conditions where the binder alloy begins to melt. Although not required, particle sizes for the particulate diamond can range from about submicrometer to 30 micrometer, while particulate sizes for the binder alloy can range from about submicrometer to about 20 micrometer. The powdered materials can be intimately mixed to form a powdered mixture. The mixture can be optionally pre-pressed to form an initial green body prior to sintering. Optional organic binders can be used to temporarily hold the powder into a given shape. Such organic binders are driven off during formation of the green body and/or during a thermal step prior to reaching sintering temperature.

In another alternative, the compact can be formed by layering the particulate diamond and the binder alloy such that the compact has a layer of compact diamond adjacent to a layer of binder alloy. The layer of binder alloy can be provided as a particulate or as a solid plate.

In one embodiment, the compact (sintered or unsintered, or partially sintered) can be formed by mixing the particulate diamond with the binder alloy without the alloying elements. The alloying elements can then be incorporated through contact at elevated temperature with a layer containing the alloying elements. The alloying element migrates via diffusion into the compact combines with the sintering catalyst to form the binder alloy in situ.

Regardless of the specific configuration of source materials, the pre-sintered body can be subjected to sintering conditions of a high temperature and high pressure. The high temperature and/or high pressure can generally correspond to sintering conditions on a phase diagram of the diamond material. In one aspect, the sintering temperature can be from about 1300° C. to about 1600° C. In another aspect, the pressure during sintering can be from 2 GPa to 8 GPa. At the sintering temperature, the binder alloy is a liquid alloy.

With the above discussion in mind, a method to improve the thermal stability as well as corrosion resistance of components made of PCD materials is provided. Various specific binder alloys can be used as the catalytic converter or binder. As a general guideline, the binder alloy can have characteristics which improve thermal stability of the final polycrystalline material. One consideration is a binder alloy which is liquid at the sintering temperature of PCD (typically 1300 to 1600° C.). Further, the binder alloy forms an intermetallic compound alloy at temperatures lower than the sintering temperature in solid state (including room temperature). As mentioned previously, the intermetallic compound alloy also has no significant solubility or no solubility for carbon. Suitable binder alloys function as the catalyst for diamond sintering similar to what Co alone does in sintering of conventional PCD materials. The alloy and the alloying elements in the alloy either do not form carbide at all, or are weaker carbide formers than tungsten. In some cases the alloy and alloying elements also are weaker carbide formers than W, Mo, Cr, Nb, Ti, Ta, V, Zr, Hf, and Fe. The alloy may also be in the form of a solid solution alloy, or a mixture of the solid solution alloy with intermetallics of the sintering catalyst, at the low temperatures. The solid solution alloy also has no significant solubility or very low solubility for carbon. The alloying elements further depress the melting point of the sintering catalyst such as cobalt or other substitute transition metals. The catalytic binder or converter could be made of other transition metals. At room temperature, the solid binder consists of substantially intermetallic alloys of transition metals including Fe, Ni, Co, Ti, V, Cr, Mn, Zr, Nb, Mo, Hf, Ta, W, Al, Si, and so forth.

As such, present exemplary alloy systems include, but not limited to the following: Co—B, Co—Al, Co—Cr, Co—Mn, Co—Si, Co—Y, and Co-M where M is one of the or mixtures of W, V, Mo, Nb, and Ti. Once used in the PCD system, the above binary systems can become ternary systems of Co-M-C, where M represents any of the above.

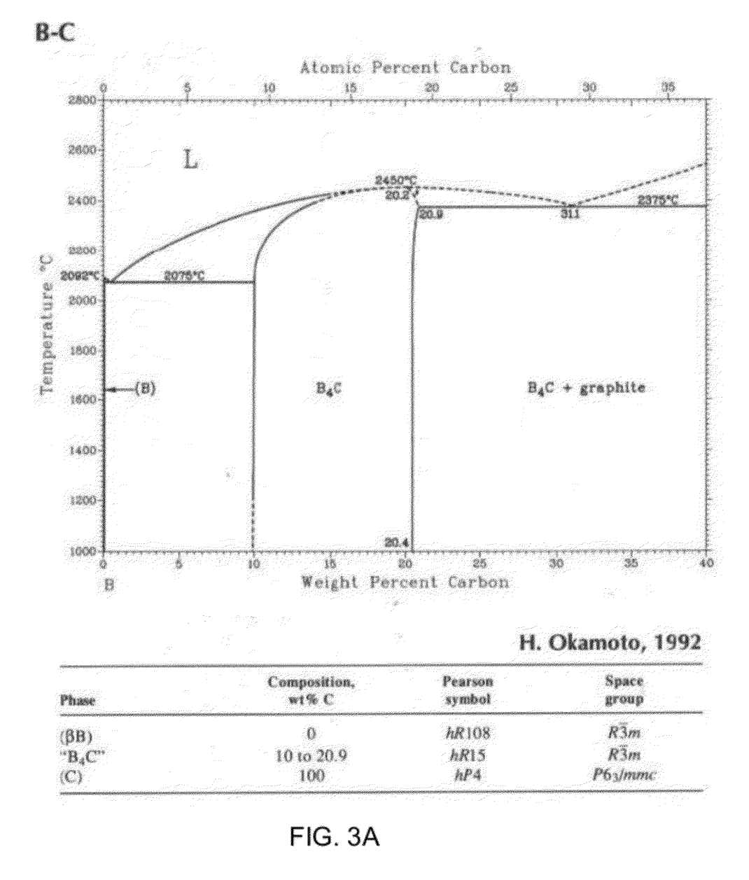

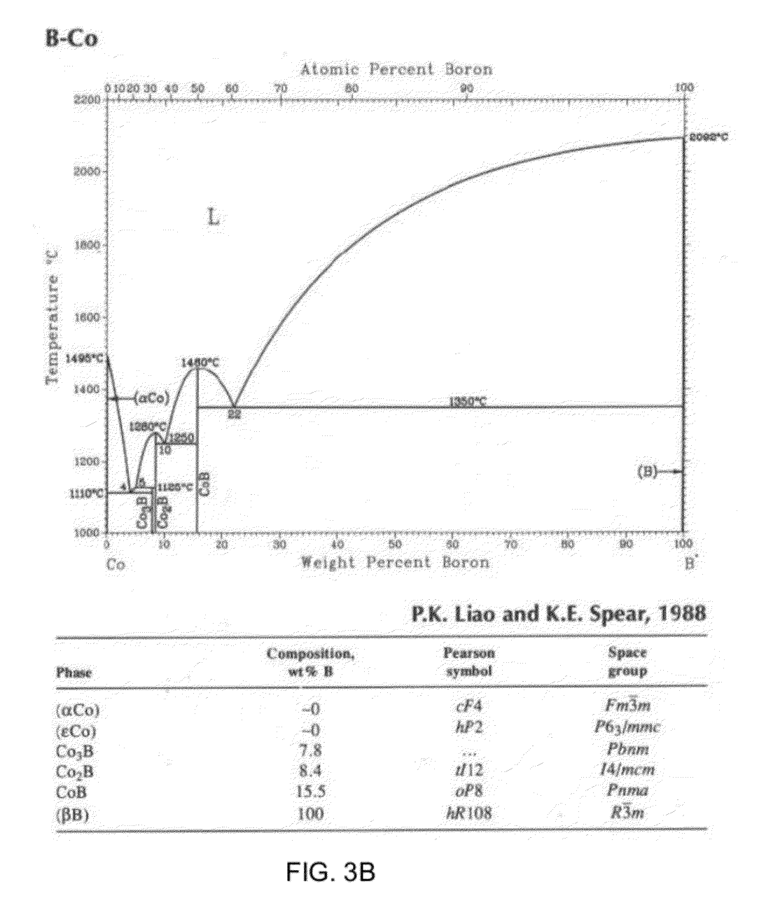

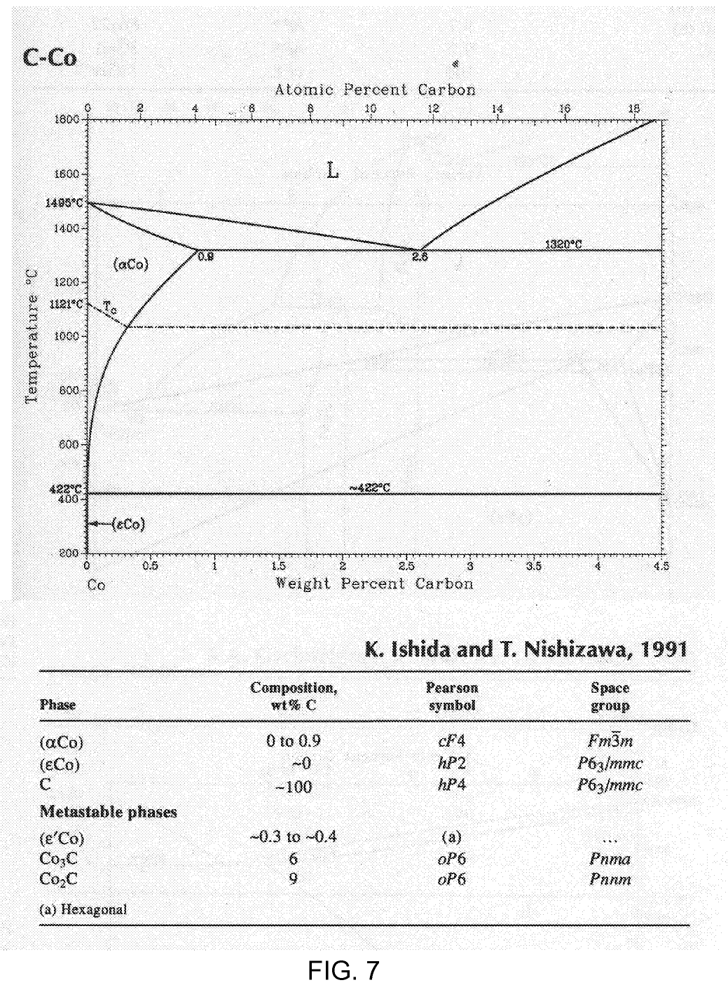

Using Co—B—C as an example with boron content less than 50 atomic percent (at. %). The phase diagrams of binary Co—B and ternary system of Co—B—C are shown in FIGS. 3A and 3B (and FIG. 7) can be used to aid understanding the ternary system. At temperatures and pressures of PCD sintering, the cobalt will be in a liquid state with B and C in the solution. The solution may contain a small amount of W as a result of ball milling prior to sintering, or W may dissolve in the solution from the WC—Co substrates. The liquid phase will facilitate the dissolution and reprecipitation processes of carbon which is the mechanism of the sintering of diamond particles. The diamond particles develops diamond-to-diamond bond during this process. Upon completion of sintering and subsequent cooling, the cobalt metal which is still alloyed with boron and carbon (and possibly W) will solidify. When the temperature is lower than approximately 1110° C., the solid alloy will become mixtures of two or multiple phases consisting of Co, Co₃B, Co₂B, and or CoB depending on exact boron content as illustrated by FIG. 3B. When B content is less than 30 at %, the binder alloy will consist of cobalt metal and Co₃B. When B % is higher than 30 at %, the microstructure will consist of Co₃B and Co₂B, and then B % continue to increase up to 50 at %, the microstructure may consist of Co₂B and CoB. Accordingly, the intermetallic alloys can have between about 20 at % and 55 at % B in order to avoid formation of significant quantity of Co metal phase or elemental B.

The intermetallic phases (Co₃B, Co₂B and CoB) do not have substantial solubility for carbon at near moderate to low temperature. It is possible, however, that Co—B intermetallics may form complex carbides with carbon.

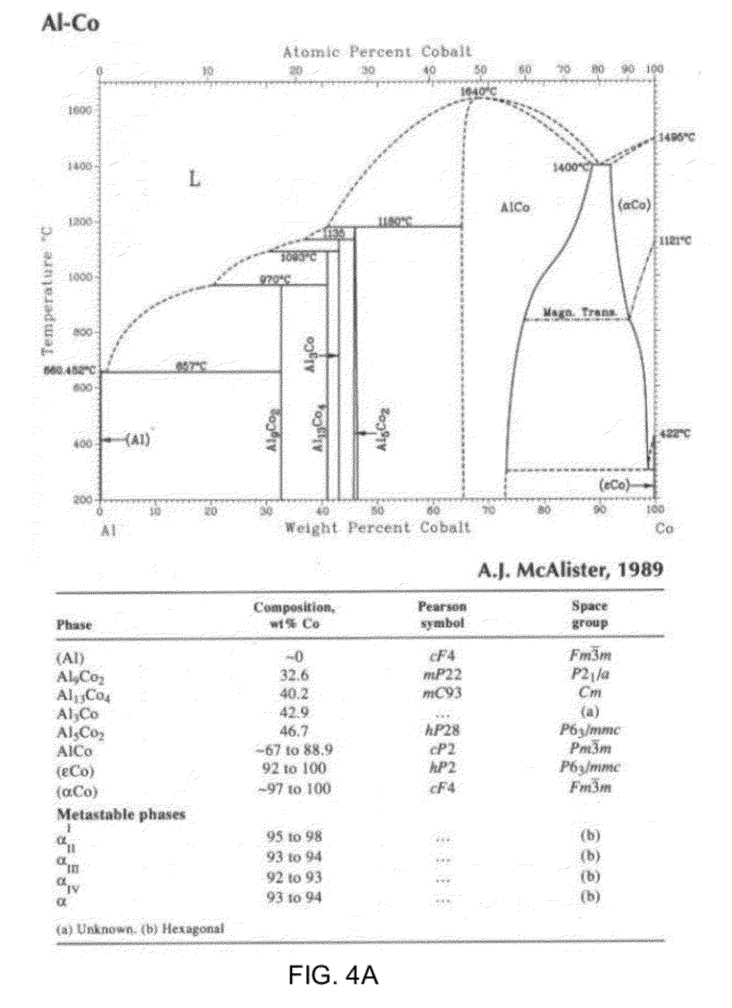

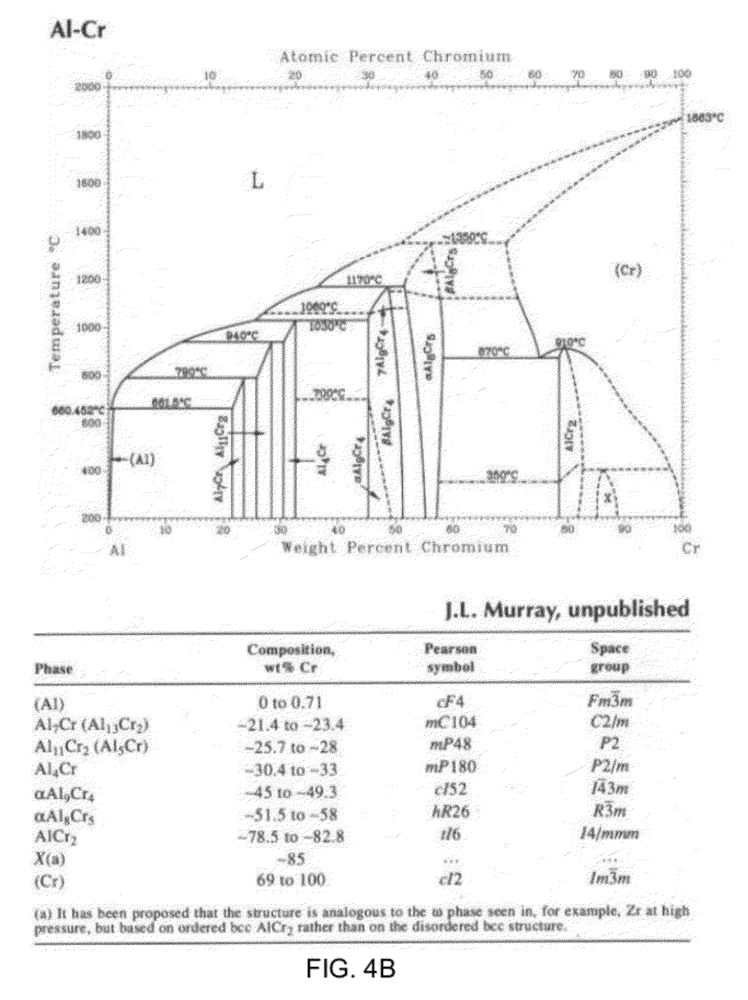

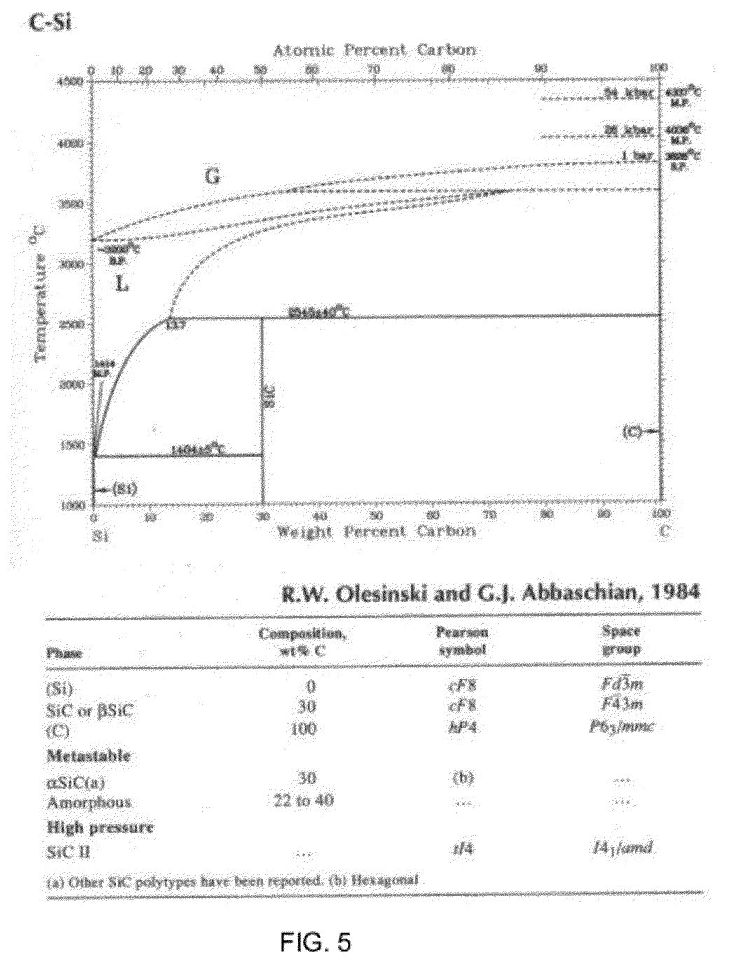

Another specific example involves the use of Al—Co alloys where aluminum is the alloying element (M₂) and cobalt is the sintering metal (M₁). Depending on the weight percent of each, the values of x and y will vary according the phase diagram shown in FIG. 4A. Based on this phase diagram, binder alloy compositions having from about 32.5 wt % to about 73 wt % cobalt will have intermetallic compounds which can be suitable. Specifically, Al₉Co₂, Al₁₃Co₄, Al₃Co, Al₅Co₂, and AlCo are formed at about 32.5 wt %, 41 wt %, 43 wt %, 46 wt %, 65.5 wt % and 73 wt %, respectively.

Yet another specific example involves the use of Al—Cr alloys where aluminum is the alloying element (M₂) and chromium is the sintering metal (M₁). Depending on the weight percent of each, the values of x and y will vary according the phase diagram shown in FIG. 4B. Based on this phase diagram, binder alloy compositions having from about 21.5 wt % to about 82 wt % chromium will have intermetallic compounds which can be suitable. Specifically, Al₇Cr, Al₁₁Cr₂, Al₄Cr, Al₉Cr₄, Al₈Cr₅, and AlCr₂ are formed at various percentages of chromium as illustrated in the phase diagram.

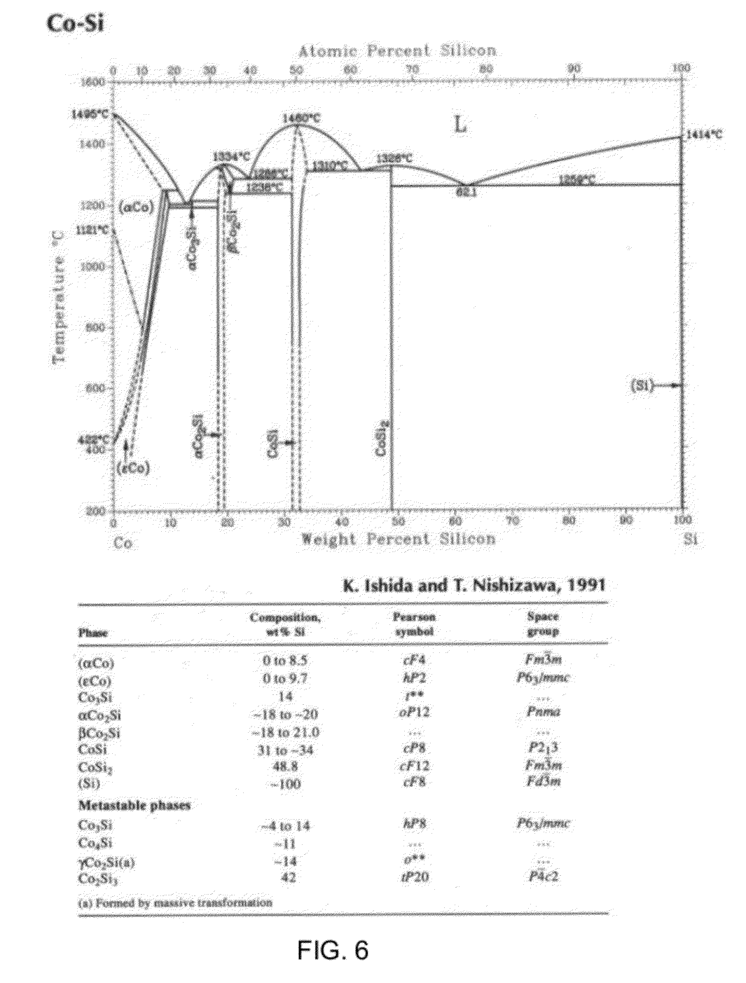

Referring now to FIG. 6, the intermetallic alloys of cobalt and silicon can be used as described with cobalt as the sintering metal (MO and silicon as the alloying element (M₂). For example, silicon content from about 18 wt % to about 49 wt % can be suitable. Specifically, Co₃Si, Co₂Si, CoSi, and CoSi₂, are formed.

The intermetallic phases are more rigid and more corrosion resistant than the cobalt metal. The intermetallic phases have no significant solubility for carbon in the solid state. Therefore, when subjected to service, the binder phase(s) will not play a “degrading” role as cobalt metal does in conventional standard PCD materials. The PCD material is thus thermally more stable than conventional PCD materials. Products and industrial tools made of PCD materials, such as shear cutters for oil and gas drilling, will be more stable and have longer useful life.

The method for making thermally stable PCD according to this invention is similar to that for making conventional PCD. Cobalt metal and boron powders can be premixed, or alloyed powders of cobalt with boron can be produced prior to PCD manufacturing. The metal alloy powder can be mixed with diamond powder and prepared for compaction and sintering according to standard procedures. When sintering it is generally desirable to reduce porosity sufficient to achieve industrially accepted quality standards. Higher porosity can be allowed, although corresponding reduction in material strength will be seen. However, such higher porosity materials will also benefit from the thermal stability provided by the binder alloys as discussed previously.

Although specific proportions can vary, the metal alloy powder can comprise from about 1 to about 20 vol % of the mixed powders including diamond. The source of alloying elements such as B, may also be placed as a separate layer on top of the powder mixture of Co with diamond. Boron (or other alloying elements) will diffuse into Co and form the desired intermetallic alloy in the final products.

One embodiment is to use the thermally stable PCD for shear cutters used on PDC drill bits. The thermally stable polycrystalline diamond materials can also be used for cutting elements on a roller-cone bit that is used for oil and gas drilling and mining applications. The thermally stable polycrystalline diamond materials can also be used to make metal cutting tools and woodworking tools. The thermally stable polycrystalline diamond materials can also be used for construction and demolition tools. The thermally stable polycrystalline diamond materials can be used for dental work tools and other bioengineering and biomedical applications. Non-limiting examples of specific tools can include machining inserts, fluted drill bit tips, end mills, circular saw tooth bits, grinding disks, cutters, cone bits, blanks, shaped drill bits, and the like.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and illustrative embodiments of the invention, it will be apparent to those of ordinary skill in the art that numerous modifications can be made without departing from the principles and concepts of the invention as set forth herein.

1. A polycrystalline diamond material, comprising
sintered interconnected and inter-bonded synthetic diamond grains; and
a binder alloy located at pockets in between diamond grains;
wherein the binder alloy is a liquid at a sintering temperature of the polycrystalline diamond, forms an intermetallic compound alloy in solid state at a lower temperature which is lower than a sintering temperature of the diamond grains, including room temperature and is substantially all intermetallic phase.

2. The polycrystalline diamond material of claim 1, wherein the binder alloy has the formula M₁ₓM_{2y}, where M₁ is a sintering catalyst and M₂ is an alloying element, and each of x and y are non-zero positive numbers corresponding to an atomic ratio in the binder alloy.

3. The polycrystalline diamond material of claim 2, wherein M₁ is selected from the group consisting of Co, Fe, Ni, and combinations thereof.

4. The polycrystalline diamond material of claim 3, wherein M₁ is cobalt.

5. The polycrystalline diamond material of claim 3, wherein M₁ is Fe or Ni.

6. The polycrystalline diamond material of claim 2, wherein the alloying element is selected from the group consisting of B, Al, Cr, Mn, Si, Y, W, V, Mo, Nb, Ti, Zr, Hf, Ta, Re, and combinations thereof.

7. The polycrystalline diamond material of claim 6, wherein the alloying element is B.

8. The polycrystalline diamond material of claim 1, wherein intermetallic compound alloy is multiphase and at least one of Co₃B, Co₂B, and CoB.

9. The polycrystalline diamond material of claim 1, wherein the binder alloy does not form carbide or is a weaker carbide former than tungsten.

10. The polycrystalline diamond material of claim 1, wherein the binder alloy is a solid at temperatures lower than the sintering temperature including room temperature and solubilizes carbon in the amount of 1.0 percent by weight or less.

11. The polycrystalline diamond material of claim 1, wherein the intermetallic compound alloy is a mixture of intermetallic compound with a minor fraction of solid solution alloy.

12. The polycrystalline diamond material of claim 1, wherein the sintering temperature is about 1300° C. to about 1600° C.

13. The polycrystalline diamond material of claim 1, wherein the binder alloy is selected from the group consisting of: Co—B; Co—Al; Co—Cr; Co—Mn; Co—Si; Co—Y; Co-M, where M is one of, or mixtures of, W, V, Mo, Nb, and Ti; and mixtures thereof.

14. The polycrystalline diamond material of claim 1, wherein the intermetallic compound alloy has the formula M₁ₓ-M_{2y}-C_{z}, where M₁ is a sintering catalyst, M₂ is an alloying element, and x, y and z are non-zero integers corresponding to a phase of the alloy.

15. The polycrystalline diamond material of claim 1, wherein the cobalt alloy is binary and becomes a ternary system described by Co-M-C, where M is B, Al, Cr, Mn, Si, Y, W, V, Mo, Nb, or Ti.

16. The polycrystalline diamond material of claim 1, wherein the binder alloy is a Co—B, where the boron is present in the alloy in a concentration of at least 20% by mole ratio.

17. A tool comprising the polycrystalline diamond material of claim 1.

18. The tool of claim 17, wherein the tool is selected from the group consisting of: shear cutter, PDC drill bit, metal cutting tool, woodworking tool, construction tool, demolition tool, dental work tool, and biomedical tool.

19. The tool of claim 17, wherein the tool is a drill bit.

20. A method of manufacturing a thermally stable polycrystalline diamond material, comprising:
forming a compact of particulate diamond and binder alloy, the binder alloy including a sintering catalyst and at least one alloying element selected from the group consisting of B, Al, Cr, Mn, Si, Y, W, V, Mo, Nb, and Ti; and
sintering the compact under high temperature and/or high pressure to form the thermally stable polycrystalline diamond material, wherein the alloying element is present at an amount sufficient that the binder alloy forms an intermetallic compound alloy at temperatures lower than the sintering temperature in solid state and room temperature and is substantially all intermetallic phase subsequent to sintering.

21. The method of claim 20, wherein the compact is formed by mixing the particulate diamond with the binder alloy.

22. The method of claim 20, wherein the compact is formed by layering the particulate diamond and the binder alloy such that the compact has a single layer of compact diamond adjacent to a single layer of binder alloy.

23. The method of claim 20, wherein the alloying element is diffused under elevated temperatures and pressures into a pre-fabricated fully sintered polycrystalline diamond compact by contacting with a layer containing the alloying element to form the thermally stable polycrystalline diamond material.

24. The method of claim 20, further comprising controlling the temperature and/or pressure to substantially eliminate the formation of binder alloy compounds that solubilize carbon in the amount of 1.0 percent by weight or less at solid state.
